(19) United States
(12) Patent Application Publication
(10) Pub. No.: US 2016/0253046 A1
(43) Pub. Date: Sep. 1, 2016

(54) RECORDING SYSTEM STATE DATA AND PRESENTING A NAVIGABLE GRAPHICAL USER INTERFACE

(71) Applicant: Cisco Technology, Inc., San Jose, CA (US)

(72) Inventors: Daniel Robert Garrison, San Jose, CA (US); Ali Ebtekar, Palo Alto, CA (US)

(21) Appl. No.: 14/796,333

(22) Filed: Jul. 10, 2015

Related U.S. Application Data
(60) Provisional application No. 62/126,003, filed on Feb. 27, 2015.

(51) Int. Cl. G06F 3/0481

(52) U.S. Cl. CPC G06F 3/0481

(57) ABSTRACT

Systems, methods, and computer-readable media for recording system state data and displaying the system state data in a navigable graphical user interface are disclosed. An example method includes detecting a first predefined event in a system. The example method includes, in response to detecting the first predefined event, recording and storing one or more states of the system in a first object. The example method then includes detecting a second predefined event in the system. The example method includes, in response to detecting the second predefined event, recording and storing one or more states of the system in a second object. The example method then includes displaying the first object and the second object on a navigable timeline in a graphical user interface. The first or second predefined event in the system can be a virtual private network, firewall, remote access, or web security network error.

### CROSS-REFERENCE TO RELATED APPLICATION

This application claims priority to U.S. provisional application No. 62/126,003, filed on Feb. 27, 2015, which is expressly incorporated by reference herein in its entirety.

### TECHNICAL FIELD

The present technology pertains to networking tools, and more specifically to network visualization tools and graphical user interfaces for network management and administration.

### BACKGROUND

Conventional time navigation tools for viewing states of a system at a given point of time store system data at fixed time intervals. Furthermore, in conventional analytics applications, time range selectors or time pickers are typically bound to a fixed set of data, displayed in a generic format. Thus convention tools result in a system storing large amounts of irrelevant data and make time-based navigation to detect, analyze, and correct network issues and errors more difficult and complex.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a schematic block diagram of an example cloud architecture including nodes/devices interconnected by various methods of communication;

FIG. 2 illustrates a schematic block diagram of an example cloud service management system;

FIG. 3 illustrates an example architecture for a software defined network;

FIG. 4 illustrates an example system for virtualization;

FIG. 5 illustrates an example graphical user interface for allowing a user to navigate stored system state data;

FIG. 6 illustrates another example graphical user interface for allowing a user to navigate stored system state data;

FIG. 7 illustrates an example method for recording system state data and presenting the system state data in a navigable graphical user interface;

FIG. 8 illustrates an example network device; and

FIGS. 9A and 9B illustrate example system embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein can be used to record system state data, including network system state data, and present the recorded system state data in a navigable graphical user interface.

An example method includes detecting a first predefined event in a system. The example method includes, in response to detecting the first predefined event, recording and storing one or more states of the system in a first object. The example method then includes detecting a second predefined event in the system. The example method includes, in response to detecting the second predefined event, recording and storing one or more states of the system in a second object. The example method then includes displaying the first object and the second object on a navigable timeline in a graphical user interface.

In a first variation of the example method, the first predetermined event includes a lifecycle and the recording and storing of one or more states of the system in the first object further includes recording and storing a first state of the system at a first stage of the lifecycle of the first predetermined event and recording and storing a second state of the system at a second stage of the lifecycle of the first predetermined event.

The first variation of the example method can include an aspect in which displaying the first object on the navigable timeline in the graphical user interface further includes displaying a sub-object representing the first state of the system at the first stage of the lifecycle and displaying a sub-object representing the second state of the system at the second stage. This aspect can include displaying the sub-object representing the first state of the system at the first stage of the lifecycle and displaying the sub-object representing the second state of the system at the second stage only occurs in response to receiving a user input.

The example method can include an aspect in which displaying the first object and the second object on the navigable timeline in the graphical user interface further includes displaying the first object and second object in chronological order.

As examples, the first or second predefined event in the system can be a virtual private network, firewall, remote access, or web security network error.

The disclosed technology allows for more efficient storage of server state data and also for an enhanced graphical user interface for stored system state data. The enhanced graphical user interface allows a user to diagnose, troubleshoot, and fix system errors faster and more intuitively. These example advantages are non-limiting and one of ordinary skill in the art will recognize other advantages from the disclosed technology.

### Description

A computer network can include a system of hardware, software, protocols, and transmission components that collectively allow separate devices to communicate, share data, and access resources such as software applications. More specifically, a computer network is a geographically distributed collection of nodes interconnected by communication links and segments for transporting data between endpoints, such as personal computers and workstations. Many types of networks are available, ranging from local area networks (LANs) and wide area networks (WANs) to overlay networks and software-defined networks, such as virtual extensible local area networks (VXLANs), and virtual networks such as virtual LANs (VLANs) and virtual private networks (VPNs).

LANs typically connect nodes over dedicated private communication links located in the same general physical location, such as a building or campus. WANs, on the other hand, typically connect geographically dispersed nodes over long-distance communication links, such as common carrier telephone lines, optical lightpaths, synchronous optical networks (SONET), or synchronous digital hierarchy (SDH) links. LANs and WANs can include layer 2 (L2) and/or layer 3 (L3) networks and devices.

The Internet is an example of a public WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol can refer to a set of rules defining how the nodes interact with each other. Intermediate network nodes, such as routers, switches, hubs, or access points, which can effectively extend the size or footprint of the network, may further interconnect computer networks.

Networks can be segmented into subnetworks to provide a hierarchical, multilevel routing structure. For example, a network can be segmented into subnetworks using subnet addressing to create network segments. This way, a network can allocate various groups of IP addresses to specific network segments and divide the network into multiple logical networks.

In addition, networks can be divided into logical segments called virtual networks, such as VLANs, which connect logical segments. For example, one or more LANs can be logically segmented to form a VLAN. A VLAN allows a group of machines to communicate as if they were in the same physical network, regardless of their actual physical location. Thus, machines located on different physical LANs can communicate as if they were located on the same physical LAN. Interconnections between networks and devices can also be created using routers and tunnels, such as VPN tunnels. Tunnels can encrypt point-to-point logical connections across an intermediate network, such as a public network like the Internet. This allows secure communications between the logical connections and across the intermediate network. By interconnecting networks, the number and geographic scope of machines interconnected, as well as the amount of data, resources, and services available to users can be increased.

Further, networks can be extended through network virtualization. Network virtualization allows hardware and software resources to be combined in a virtual network. For example, network virtualization can allow multiple numbers of VMs to be attached to the physical network via respective VLANs. The VMs can be grouped according to their respective VLAN, and can communicate with other VMs as well as other devices on the internal or external network.

To illustrate, overlay and software defined networks generally allow virtual networks to be created and layered over a physical network infrastructure. Overlay network protocols, such as Virtual Extensible LAN (VXLAN), Network Virtualization using Generic Routing Encapsulation (NVGRE), Network Virtualization Overlays (NVO3), and Stateless Transport Tunneling (STT), provide a traffic encapsulation scheme that allows network traffic to be carried across L2 and L3 networks over a logical tunnel. Such logical tunnels can be originated and terminated through virtual tunnel end points (VTEPs).

Moreover, overlay networks can include virtual segments, such as VXLAN segments in a VXLAN overlay network, which can include virtual L2 and/or L3 overlay networks over which VMs communicate. The virtual segments can be identified through a virtual network identifier (VNI), such as a VXLAN network identifier, which can specifically identify an associated virtual segment or domain.

Networks can include various hardware or software appliances or nodes to support data communications, security, and provision services. For example, networks can include routers, hubs, switches, APs, firewalls, repeaters, intrusion detectors, servers, VMs, load balancers, application delivery controllers (ADCs), and other hardware or software appliances. Such appliances can be distributed or deployed over one or more physical, overlay, or logical networks. Moreover, appliances can be deployed as clusters, which can be formed using layer 2 (L2) and layer 3 (L3) technologies. Clusters can provide high availability, redundancy, and load balancing for flows associated with specific appliances or nodes. A flow can include packets that have the same source and destination information. Thus, packets originating from device A to service node B can all be part of the same flow.

Endpoint groups (EPGs) can also be used in a network for mapping applications to the network. In particular, EPGs can use a grouping of application endpoints in a network to apply connectivity and policy to the group of applications. EPGs can act as a container for groups or collections of applications, or application components, and tiers for implementing forwarding and policy logic. EPGs also allow separation of network policy, security, and forwarding from addressing by instead using logical application boundaries.

Appliances or nodes, as well as clusters, can be implemented in cloud deployments. Cloud deployments can be provided in one or more networks to provision computing services using shared resources. Cloud computing can generally include Internet-based computing in which computing resources are dynamically provisioned and allocated to client or user computers or other devices on-demand, from a collection of resources available via the network (e.g., “the cloud”). Cloud computing resources, for example, can include any type of resource, such as computing, storage, network devices, applications, virtual machines (VMs), services, and so forth. For instance, resources may include service devices (e.g., firewalls, deep packet inspectors, traffic monitors, load balancers, etc.), computer/processing devices (e.g., servers, CPUs, memory, brute force processing capability), storage devices (e.g., network attached storages, storage area network devices), etc. In addition, such resources may be used to support virtual networks, virtual machines (VM), databases, applications (Apps), etc. Also, services may include various types of services, such as monitoring services, management services, communication services, data services, bandwidth services, routing services, configuration services, wireless services, architecture services, etc.

The cloud may include a “private cloud,” a “public cloud,” and/or a “hybrid cloud.” A “hybrid cloud” can be a cloud infrastructure composed of two or more clouds that inter-operate or federate through technology. In essence, a hybrid cloud is an interaction between private and public clouds where a private cloud joins a public cloud and utilizes public cloud resources in a secure and scalable manner. In some cases, the cloud can include one or more cloud controllers which can help manage and interconnect various elements in the cloud as well as tenants or clients connected to the cloud.

Cloud controllers and/or other cloud devices can be configured for cloud management. These devices can be pre-configured (i.e., come “out of the box”) with centralized management, layer 7 (L7) device and application visibility, real time web-based diagnostics, monitoring, reporting, management, and so forth. As such, in some embodiments, the cloud can provide centralized management, visibility, monitoring, diagnostics, reporting, configuration (e.g., wireless, network, device, or protocol configuration), traffic distribution or redistribution, backup, disaster recovery, control, and any other service. In some cases, this can be done without the cost and complexity of specific appliances or overlay management software.

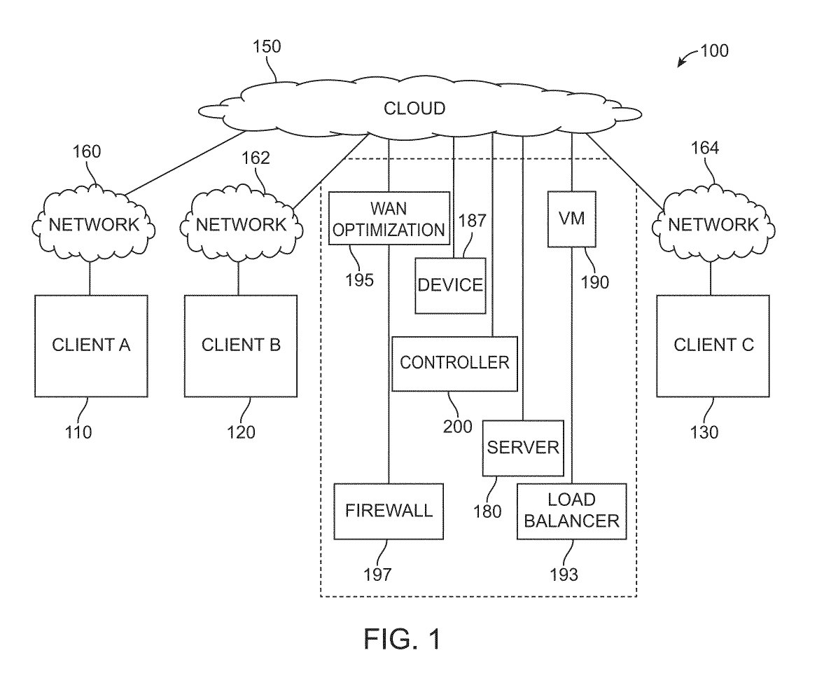

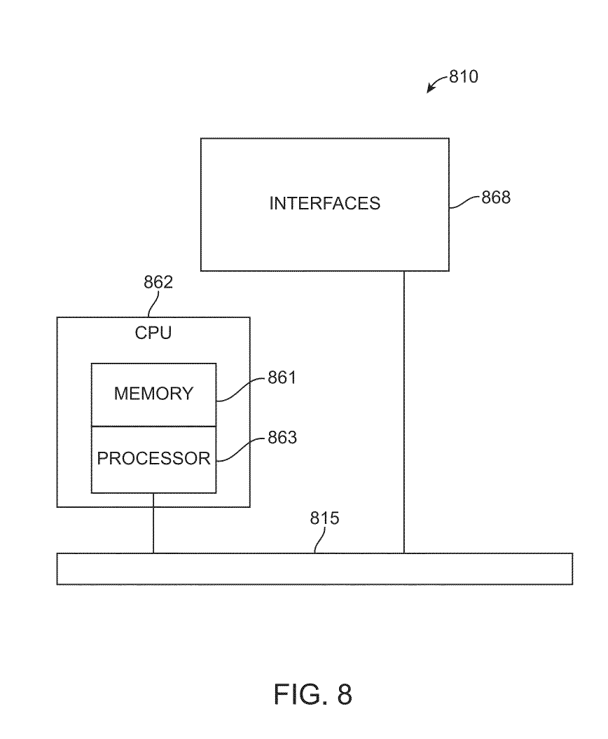

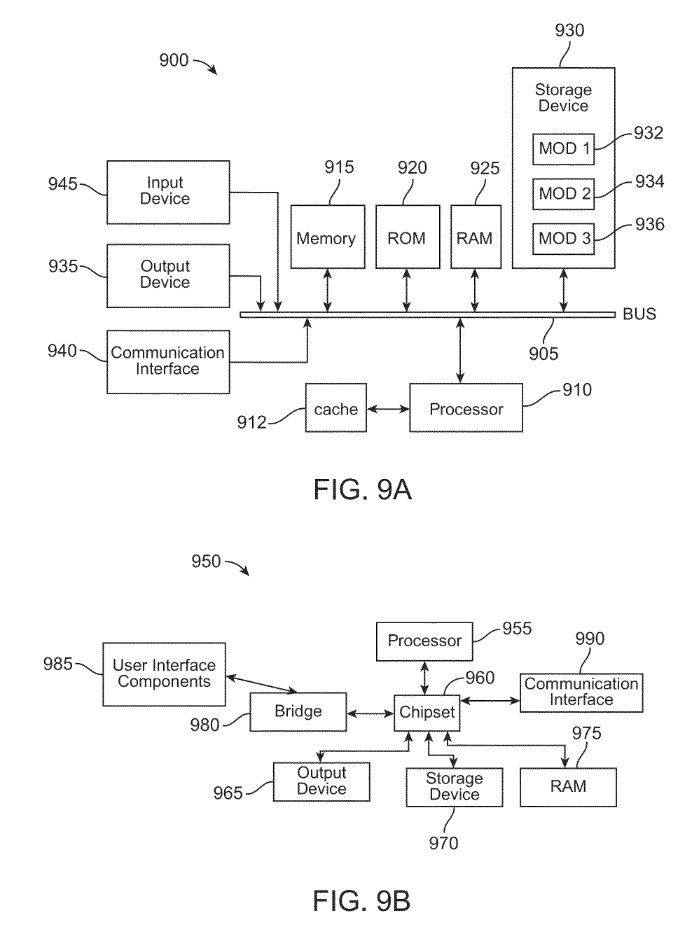

The disclosed technology addresses the need in the art for improved recording of system state data and improved graphical user interfaces for navigating the recorded system state data. A description of cloud and virtual computing environments, as illustrated in FIGS. 1 through 4, is first disclosed herein. A discussion of graphical user interfaces that allow navigation of recorded system data will then follow. The discussion then concludes with a brief description of example devices, as illustrated in FIGS. 8 and 9. These variations shall be described herein as the various embodiments are set forth. The disclosure now turns to FIG. 1.

FIG. 1 illustrates a schematic block diagram of an example cloud architecture 100 including nodes/devices interconnected by various methods of communication. Cloud 150 can be a public, private, and/or hybrid cloud system. Cloud 150 can include resources, such as one or more Firewalls 197; Load Balancers 193; WAN optimization platforms 195; devices 187, such as switches, routers, intrusion detection systems, Auto VPN systems, or any hardware or software network device; servers 180, such as dynamic host configuration protocol (DHCP), domain naming system (DNS), or storage servers; virtual machines (VMs) 190; controllers 200, such as a cloud controller or a management device; or any other resource.

Cloud resources can be physical, software, virtual, or any combination thereof. For example, a cloud resource can include a server running one or more VMs or storing one or more databases. Moreover, cloud resources can be provisioned based on requests (e.g., client or tenant requests), schedules, triggers, events, signals, messages, alerts, agreements, necessity, or any other factor. For example, the cloud 150 can provision application services, storage services, management services, monitoring services, configuration services, administration services, backup services, disaster recovery services, bandwidth or performance services, intrusion detection services, VPN services, or any type of services to any device, server, network, client, or tenant.

In addition, cloud 150 can handle traffic and/or provision services. For example, cloud 150 can provide configuration services, such as auto VPN, automated deployments, automated wireless configurations, automated policy implementations, and so forth. In some cases, the cloud 150 can collect data about a client or network and generate configuration settings for specific service, device, or networking deployments. For example, the cloud 150 can generate security policies, subnetting and routing schemes, forwarding schemes, NAT settings, VPN settings, and/or any other type of configurations. The cloud 150 can then push or transmit the necessary data and settings to specific devices or components to manage a specific implementation or deployment. For example, the cloud 150 can generate VPN settings, such as IP mappings, port number, and security information, and send the VPN settings to specific, relevant device(s) or component(s) identified by the cloud 150 or otherwise designated. The relevant device(s) or component(s) can then use the VPN settings to establish a VPN tunnel according to the settings. As another example, the cloud 150 can generate and manage network diagnostic tools or graphical user interfaces.

To further illustrate, cloud 150 can provide specific services for client A (110), client B (120), and client C (130). For example, cloud 150 can deploy a network or specific network components, configure links or devices, automate services or functions, or provide any other services for client A (110), client B (120), and client C (130). Other non-limiting example services by cloud 150 can include network administration services, network monitoring services, content filtering services, application control, WAN optimization, firewall services, gateway services, storage services, protocol configuration services, wireless deployment services, and so forth.

To this end, client A (110), client B (120), and client C (130) can connect with cloud 150 through networks 160, 162, and 164, respectively. More specifically, client A (110), client B (120), and client C (130) can each connect with cloud 150 through networks 160, 162, and 164, respectively, in order to access resources from cloud 150, communicate with cloud 150, or receive any services from cloud 150. Networks 160, 162, and 164 can each refer to a public network, such as the Internet; a private network, such as a LAN; a combination of networks; or any other network, such as a VPN or an overlay network.

Moreover, client A (110), client B (120), and client C (130) can each include one or more networks. For example, client A (110), client B (120), and client C (130) can each include one or more LANs and VLANs. In some cases, a client can represent one branch network, such as a LAN, or multiple branch networks, such as multiple remote networks. For example, client A (110) can represent a single LAN network or branch, or multiple branches or networks, such as a branch building or office network in Los Angeles and another branch building or office network in New York. If a client includes multiple branches or networks, the multiple branches or networks can each have a designated connection to the cloud 150. For example, each branch or network can maintain a tunnel to the cloud 150. Alternatively, all branches or networks for a specific client can connect to the cloud 150 via one or more specific branches or networks. For example, traffic for the different branches or networks of a client can be routed through one or more specific branches or networks. Further, client A (110), client B (120), and client C (130) can each include one or more routers, switches, appliances, client devices, VMs, or any other devices.

Each client can also maintain links between branches. For example, client A can have two branches, and the branches can maintain a link between each other. Thus, in some cases, branches can maintain a tunnel between each other, such as a VPN tunnel. Moreover, the link or tunnel between branches can be generated and/or maintained by the cloud 150. For example, the cloud 150 can collect network and address settings for each branch and use those settings to establish a tunnel between branches. In some cases, the branches can use a respective tunnel between the respective branch and the cloud 150 to establish the tunnel between branches. For example, branch 1 can communicate with cloud 150 through a tunnel between branch 1 and cloud 150 to obtain the settings for establishing a tunnel between branch 1 and branch 2. Branch 2 can similarly communicate with cloud 150 through a tunnel between branch 2 and cloud 150 to obtain the settings for the tunnel between branch 1 and branch 2.

In some cases, cloud 150 can maintain information about each client network in order to provide or support specific services for each client, such as security or VPN services. Cloud 150 can also maintain one or more links or tunnels to client A (110), client B (120), and/or client C (130). For example, cloud 150 can maintain a VPN tunnel to one or more devices in client A's network. In some cases, cloud 150 can configure the VPN tunnel for a client, maintain the VPN tunnel, or automatically update or establish any link or tunnel to the client or any devices of the client.

The cloud 150 can also monitor device and network health and status information for client A (110), client B (120), and client C (130). To this end, client A (110), client B (120), and client C (130) can synchronize information with cloud 150. Cloud 150 can also manage and deploy services for client A (110), client B (120), and client C (130). For example, cloud 150 can collect network information about client A and generate network and device settings to automatically deploy a service for client A. In addition, cloud 150 can update device, network, and service settings for client A (110), client B (120), and client C (130).

Those skilled in the art will understand that the cloud architecture 150 can include any number of nodes, devices, links, networks, or components. In fact, embodiments with different numbers and/or types of clients, networks, nodes, cloud components, servers, software components, devices, virtual or physical resources, configurations, topologies, services, appliances, deployments, or network devices are also contemplated herein. Further, cloud 150 can include any number or type of resources, which can be accessed and utilized by clients or tenants. The illustration and examples provided herein are for clarity and simplicity.

Moreover as far as communications, packets (e.g., traffic and/or messages) can be exchanged among the various nodes and networks in the cloud architecture 100 using specific network protocols. In particular, packets can be exchanged using wired protocols, wireless protocols, security protocols, OSI-Layer specific protocols, or any other protocols. Some non-limiting examples of protocols can include protocols from the Internet Protocol Suite, such as TCP/IP; OSI (Open Systems Interconnection) protocols, such as L1-L7 protocols; routing protocols, such as RIP, IGP, BGP, STP, ARP, OSPF, EIGRP, NAT; or any other protocols or standards, such as HTTP, SSH, SSL, RTP, FTP, SMTP, POP, PPP, NNTP, IMAP, Telnet, SSL, SFTP, WIFI, Bluetooth, VTP, ISL, IEEE 802 standards, L2TP, IPSec, etc. In addition, various hardware and software components or devices can be implemented to facilitate communications both within a network and between networks. For example, switches, hubs, routers, access points (APs), antennas, network interface cards (NICs), modules, cables, firewalls, servers, repeaters, sensors, etc.

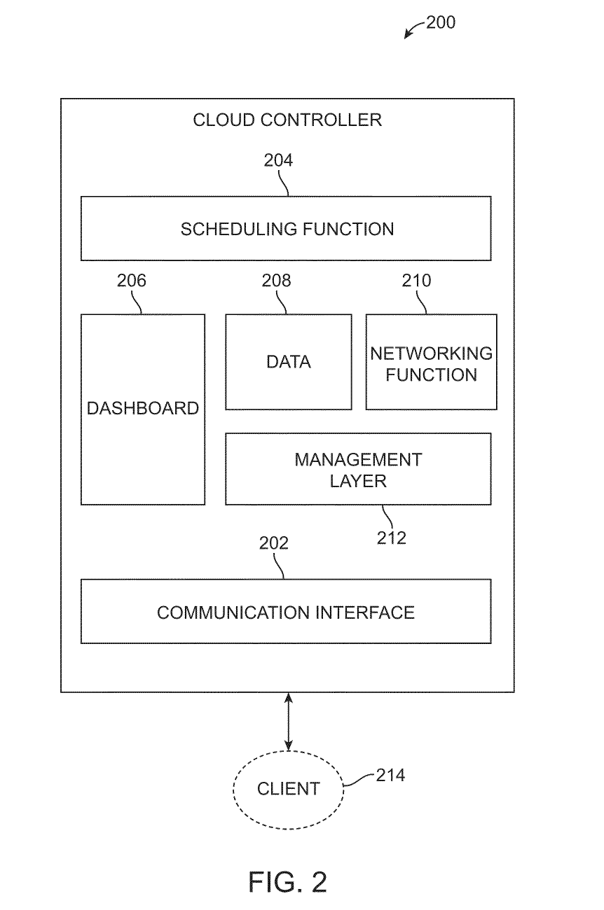

FIG. 2 illustrates a schematic block diagram of an example cloud controller 200. The cloud controller 200 can serve as a cloud service management system for the cloud 150. In particular, the cloud controller 200 can manage cloud operations, client communications, service provisioning, network configuration and monitoring, etc. For example, the cloud controller 200 can manage cloud service provisioning, such as cloud storage, media, streaming, security, or administration services. In some embodiments, the cloud controller 200 can manage VMs; networks, such as client networks or software-defined networks (SDNs); service provisioning; etc.

The cloud controller 200 can include several subcomponents, such as a scheduling function 204, a dashboard 206, data 208, a networking function 210, a management layer 212, and a communications interface 202. The various subcomponents can be implemented as hardware and/or software components. Moreover, although FIG. 2 illustrates one example configuration of the various components of the cloud controller 200, those of skill in the art will understand that the components can be configured in a number of different ways and can include any other type and number of components. For example, the networking function 210 and management layer 212 can belong to one software module or multiple separate modules. Other modules can be combined or further divided up into more subcomponents.

The scheduling function 204 can manage scheduling of procedures, events, or communications. For example, the scheduling function 204 can schedule when resources should be allocated from the cloud 150. As another example, the scheduling function 204 can schedule when specific instructions or commands should be transmitted to the client 214. In some cases, the scheduling function 204 can provide scheduling for operations performed or executed by the various subcomponents of the cloud controller 200. The scheduling function 204 can also schedule resource slots, virtual machines, bandwidth, device activity, status changes, nodes, updates, etc.

The dashboard 206 can provide a frontend where clients can access or consume cloud services. For example, the dashboard 206 can provide a web-based frontend where clients can configure client devices or networks that are cloud-managed, provide client preferences, specify policies, enter data, upload statistics, configure interactions or operations, etc. In some cases, the dashboard 206 can provide visibility information, such as views of client networks or devices. For example, the dashboard 206 can provide a view of the status or conditions of the client's network, the operations taking place, services, performance, a topology or layout, specific network devices, protocols implemented, running processes, errors, notifications, alerts, network structure, ongoing communications, data analysis, etc.

In some cases, the dashboard 206 can provide a graphical user interface (GUI) for the client 214 to monitor the client network, the devices, statistics, errors, notifications, etc., and even make modifications or setting changes through the GUI. The GUI can depict charts, lists, tables, tiles, network trees, maps, topologies, symbols, structures, or any graphical object or element. In addition, the GUI can use color, font, shapes, or any other characteristics to depict scores, alerts, or conditions. In some cases, the dashboard 206 can also handle user or client requests. For example, the client 214 can enter a service request through the dashboard 206.

The data 208 can include any data or information, such as management data, statistics, settings, preferences, profile data, logs, notifications, attributes, configuration parameters, client information, network information, and so forth. For example, the cloud controller 200 can collect network statistics from the client 214 and store the statistics as part of the data 208. In some cases, the data 208 can include performance and/or configuration information. This way, the cloud controller 200 can use the data 208 to perform management or service operations for the client 214. The data 208 can be stored on a storage or memory device on the cloud controller 200, a separate storage device connected to the cloud controller 200, or a remote storage device in communication with the cloud controller 200.

The networking function 210 can perform networking calculations, such as network addressing, or networking services or operations, such as auto VPN configuration or traffic routing. For example, the networking function 210 can perform filtering functions, switching functions, failover functions, high availability functions, network or device deployment functions, resource allocation functions, messaging functions, traffic analysis functions, port configuration functions, mapping functions, packet manipulation functions, path calculation functions, loop detection, cost calculation, error detection, or otherwise manipulate data or networking devices. In some embodiments, the networking function 210 can handle networking requests from other networks or devices and establish links between devices. In other embodiments, the networking function 210 can perform queuing, messaging, or protocol operations.

The management layer 212 can include logic to perform management operations. For example, the management layer 212 can include the logic to allow the various components of the cloud controller 200 to interface and work together. The management layer 212 can also include the logic, functions, software, and procedure to allow the cloud controller 200 to perform monitoring, management, control, and administration operations of other devices, the cloud 150, the client 214, applications in the cloud 150, services provided to the client 214, or any other component or procedure. The management layer 212 can include the logic to operate the cloud controller 200 and perform particular services configured on the cloud controller 200.

Moreover, the management layer 212 can initiate, enable, or launch other instances in the cloud controller 200 and/or the cloud 150. In some embodiments, the management layer 212 can also provide authentication and security services for the cloud 150, the client 214, the controller 214, and/or any other device or component. Further, the management layer 212 can manage nodes, resources, VMs, settings, policies, protocols, communications, etc. In some embodiments, the management layer 212 and the networking function 210 can be part of the same module. However, in other embodiments, the management layer 212 and networking function 210 can be separate layers and/or modules.

The communications interface 202 allows the cloud controller 200 to communicate with the client 214, as well as any other device or network. The communications interface 202 can be a network interface card (NIC), and can include wired and/or wireless capabilities. The communications interface 202 allows the cloud controller 200 to send and receive data from other devices and networks. In some embodiments, the cloud controller 200 can include multiple communications interfaces for redundancy or failover. For example, the cloud controller 200 can include dual NICs for connection redundancy.

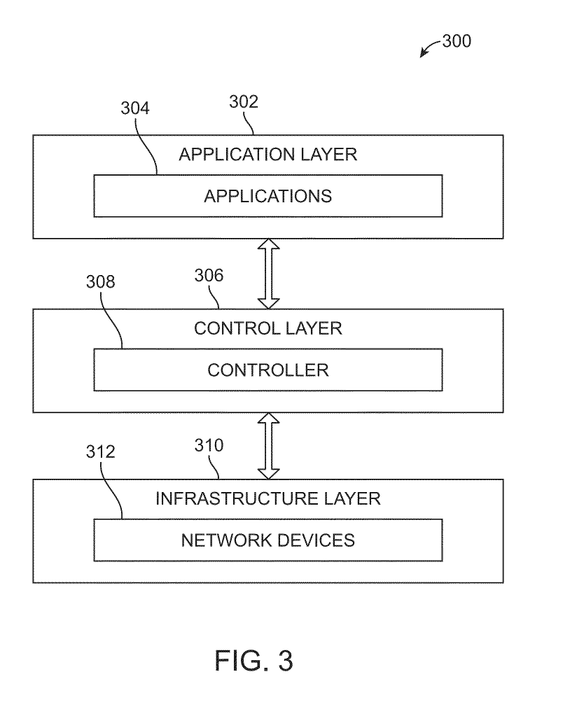

FIG. 3 illustrates example architecture 300 of a software-defined network (SDN). The architecture 300 can include an application layer 302, a controller layer 306, and an infrastructure layer 310. The application layer 302 serves as the application lane and can include one or more applications 304, such as business applications, network services, utilities, appliances, or any other applications. The applications 304 in the application layer 302 interface with the control level to communicate their needs and requirements to the control layer 306.

The control layer 306 serves as the control plane, which can control traffic flow based on the infrastructure layer 310 and the instructions specified by the application layer 310. The control layer 306 can include a controller 308, which can be a centralized entity that provides the control logic. The controller 308 can include an agent for interfacing with the application layer 302 and driver(s) for interfacing with the infrastructure layer 310.

The infrastructure layer 310 can include the physical resources associated with the data plane. The infrastructure layer 310 can include one or more network devices 312 that interface with the control layer 306. The infrastructure layer 310 can also include the data and/or the process for forwarding data to the target destination.

The architecture 300 allows management of services and applications through abstraction of low-level functionality by dividing the system for the control plane from the data plane. In some cases, the architecture 300 can include an SDN overlay running a logically separate network or network component on top of the SDN underlay (i.e., existing infrastructure). As one of ordinary skill in the art will readily recognize, the architecture 300 can be implemented in various environments and implementations. Moreover, the methods for communication between the control plane and the data plane can vary in different implementations, and can use current mechanisms or any other current or future mechanisms.

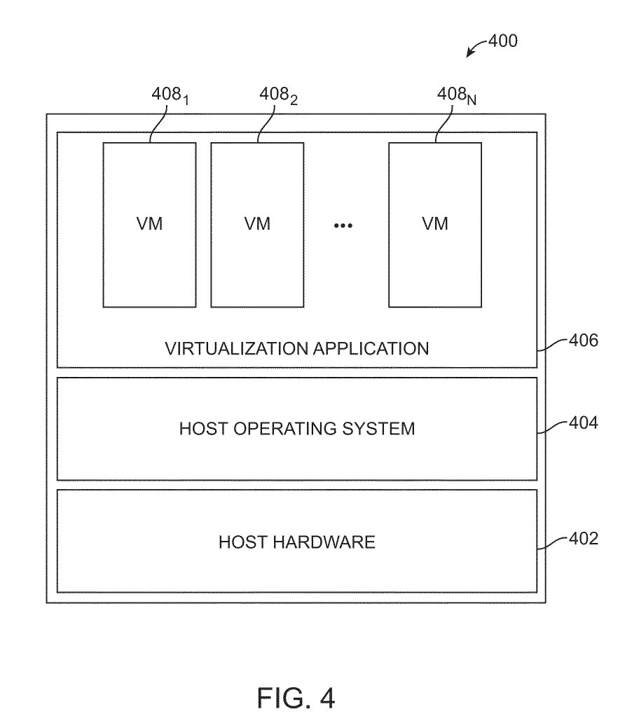

FIG. 4 illustrates an example system 400 for virtualization. The system 400 can include host hardware 402. The host hardware 402 can include hardware and computer architecture for the system 400, such memory and/or resources, processing resources, communication resources, input/output resources, sensing resources, etc. For example, the host hardware 402 can include the computer architecture described below with respect to FIGS. 9A and 9B.

The system 400 can also include a host operating system 404. The host operating system 404 can provide the logic for controlling the host hardware 402. Moreover, the host operating system 404 can provide the general computing environment for the system 400. Further, virtualization application 406 can run on the host operating system 404. One or more VMs 408₁₋ₙ can be created within the virtualization application 406. The VMs 408₁₋ₙ can run guest operating systems on the system 400. The virtualization application 406 can control access to the host hardware 402 by each of the VMs 408₁₋ₙ. Each of the VMs 408₁₋ₙ can run one or more appliances, including applications, services, or utilities. This way, specific applications, services, or utilities can be virtualized through VMs 408₁₋ₙ.

In some cases, the system 400 can be a device or a server running one or more VMs, which can be setup to provide services or functionality to clients. Moreover, the system 400 can be implemented in various types of environments. For example, the system 400 can be implemented in a cloud environment, such as cloud 150; an SDN environment, such as illustrated in architecture 300; a LAN; or any combination.

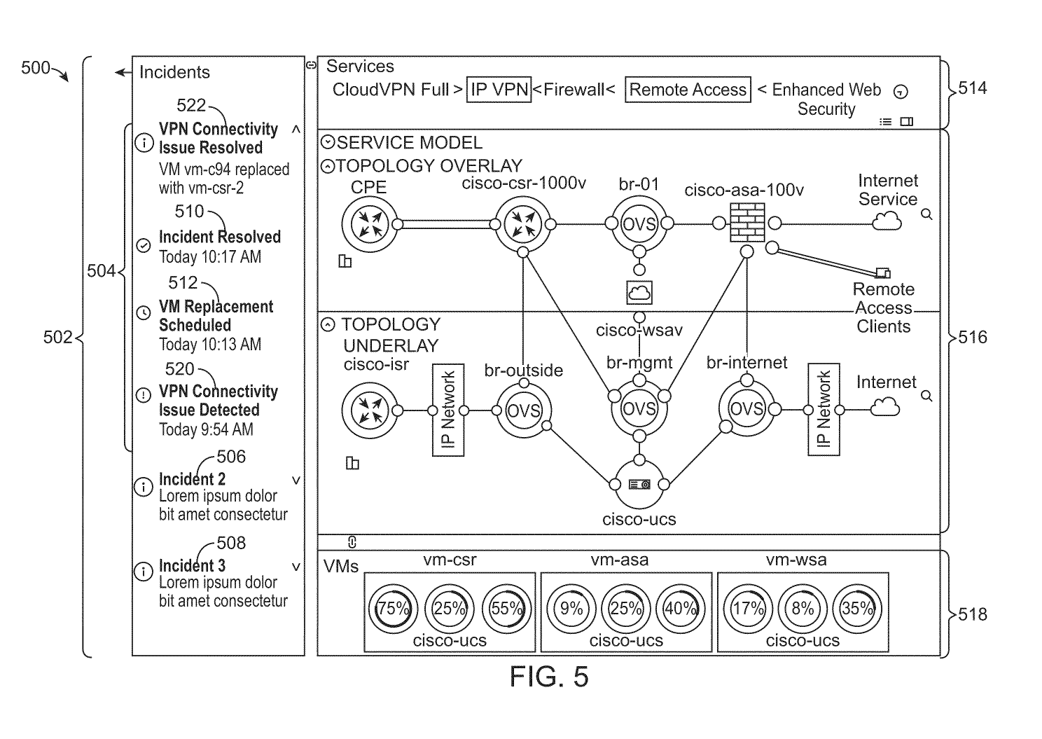

FIG. 5 illustrates an example graphical user interface for allowing a user to navigate stored system state data. FIG. 5 includes graphical user interface 500. Graphical user interface 500 includes system incidents section 502, services section 514, Topology section 516, and Virtual Machine (VM) section 518.

Services section 514, in this instance, illustrates that a customer's service includes IP Virtual Private Network, Firewall, Remote Access, and Enhanced Web Security features.

Topology section 516 illustrates a topology overlay and topology underlay in graphical user interface 500. This provides graphical topology data in real-time.

Virtual Machine (VM) section 518 illustrates data for three VMs (virtual machines) includes as shown, vm-csr, vm-asa, and vm-wsa.

System incidents section 502 includes recorded system state data for a first incident 504, recorded system state data for a second incident 506, and recorded system state data for a third incident 508.

First incident 504 is expanded, in this case due to receiving a user input, to show all known lifecycle activities for a VPN Connectivity issue. A system has recorded system state data in object 520 at 9:54 am upon detecting a VPN connectivity issue. The system has recorded system state data in object 512 at 10:13 am upon detecting a VPN replacement scheduling. The system has recorded system state data in object 510 at 10:17 am upon detecting successful completion of the VM replacement. Finally, the system has recorded system state data in object 504, which includes all known objects linked to a VPN connectivity lifecycle issue. In one embodiment, object 522 is expanded to show associated objects 510, 512, and 520 or reduced to hide objects 510, 512, and 520 in response to a received user input.

In conventional analytics applications, time range selectors or time pickers are normally bound to a fixed set of data, displaying in a generic format, and snap to data point in a generic fashion. The representations of these controls also do not have a built-in awareness of the objects they represent and their lifecycle. These limitations artificially restrict the ability of a user to more thoroughly investigate, troubleshoot, and understand the historical context and information of the object(s) of interest in a particular workflow.

The disclosed technology optimizes the logic and visualization methods of various forms of time-based analytics. The disclosed technology also enhances visual connections and correlations between different parts of the analytics views. The disclosed technology also facilitates easy access to complete visual “snapshots” of historical states of a system for auditing or further analysis of past events, incidents, and configuration changes. The disclosed technology also allows inline navigation through various states of system elements and event for quick and efficient in-context task completions. Furthermore, the disclosed technology reduces time and level of effort to troubleshoot a system.

A multifaceted time navigator for cloud and network analytics is disclosed. The navigator allows for the display of various states of a system as a whole or as individual elements in time. These states can be stored in a linear sequence and ordered chronologically, in discrete finite steps, a continuous range, or an aggregated form. There can be generally multiple facets included in this framework for navigating temporal element of a system, such as object scope, format of time, visualization, and so forth. In some embodiments, there can be three facets included in this framework: (1) Object scope of the time navigator (e.g., single object or multiple related objects), (2) Format of the time series (e.g., lifecycle-based and/or time-based), and (3) visualization (e.g., icons of various states/phases, trend or aggregate charts, etc.). The object scope of the time navigator can be a single object or multiple related objects within a view. In one example, the multiple related objects are part of a known lifecycle. In the case of multiple objects, the states of those objects can be driven contextually by another object's time series data, or globally by an overarching time navigator. In some embodiments, the visualization facet can include icons, tiles, images, thumbnails, graphical links or connections, and/or graphical representations of one or more object states or phases. In other embodiments, the visualization facet can include trend or aggregate charts (e.g., donut charts, sparkline, etc.), tables, lists, and so forth.

The format of the time series can be derived due to an awareness of the nature of the bound object(s) and/or its lifecycle. In one example, time series for object(s) can be marked based on moments in time, either based on a predetermined frequency or any state change in the object(s) content. However, some objects can have a specific known lifecycle that each passes through, and as a result, the time series in those cases can be formatted according to a more meaningful correlation to stages in the lifecycle.

In one example of a cloud-based management system, there are incidents that an operator or engineer must deal with. A first example demonstrates a time navigator when applied to a single object (e.g., an incident) and its corresponding effect on the network services and hardware (object scope=single object), and various states from detection to resolution that every incident or object goes through. The user can navigate through each lifecycle stage the object went through and view, at each snapshot, information about the state of the object at that time, as well as the corresponding affected state of the network services and hardware. The object and/or various states or phases associated with the object can be depicted according to a specific visualization scheme or construct, such as icons or graphical elements, for example. This can allow the user an unprecedented holistic understanding of the relevant objects (the incident and the affected network elements), based on this ability to view, navigate, and visualize the historical states. Thus, the structure or classifications for the navigation framework in this example can include a scope (e.g., single object or incident), a time format (e.g., lifecycle-based), and/or a visualization scheme (e.g., icons or images representing specific states or phases).

In another example of a cloud-based management system, the operator or engineer can have a time-navigator interface, such as a dashboard or workspace, providing relevant metrics on the state of the network. The interface can have a scope of multiple related objects, such as incidents, services, customers, logs, servers, service tickets, VMs, etc. Moreover, the interface can have a format that is time-based and a specific visualization type, such as trend or aggregate charts, for example. The user can have the ability to modify a time range of a given time-based data set on the interface (e.g. a performance graph). The time navigator allows the ability to view a state or phase of the entire interface at multiple times in the past (i.e., time-based) according to frequency or marked state changes. Rather than having to piece this information together manually for the purposes of troubleshooting or planning, the time navigator allows the user to easily view and compare the holistic state of relevant information and/or objects along a time continuum, and/or according to a visualization scheme, such as charts or tables, graphically depicting trends and/or aggregate data, for example.

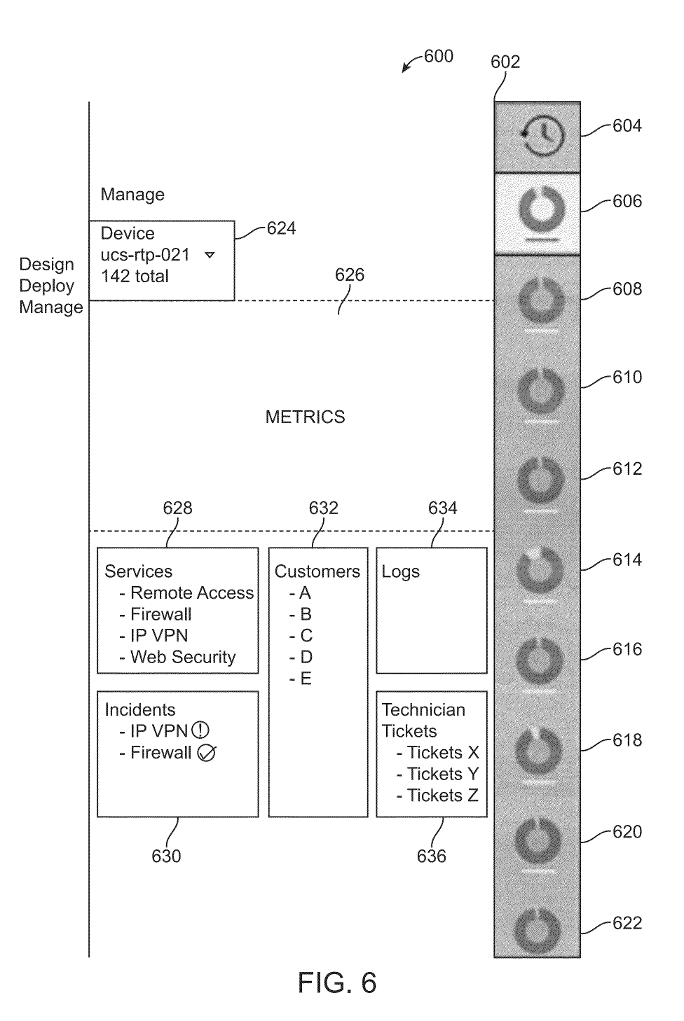

FIG. 6 illustrates another example graphical user interface 600 for allowing a user to navigate stored system state data. The graphical user interface 600 can include a time selector 602. The time selector 602 can include relevant network data visualizations 604, 606, 608, 610, 612, 614, 616, 618, 620, 622 for a chosen point in time, which can be based on a frequency, states, phases, events, intervals, conditions, snapshots, etc.

In some cases, the interface 600 can be a dashboard workspace. The dashboard workspace 600 can include objects 624-636. The objects 624-636 can include, for example, a device object 624, a metrics object 626, a services object 628, an incidents object 630, a customers object 632, a logs object 634, and a technician tickets object 636. As one of ordinary skill in the art will recognize, some embodiments can include more or less objects. Moreover, other embodiments can include different objects, such as servers object, VMs object, users object, etc.

The objects 624-636 can include representations or visualizations based on an associated scope or context. For example, a services object 628 can include a services icon with information, such as chart(s) or listings, relating to specific services. In some embodiments, the objects 624-636 can be inter-related and/or associated. For example, the services object 628 can represent services provisioned by one or more devices represented by the devices object 624. As another example, the services object 628 can represent services associated with customers represented by the customers object 632, and the technician tickets object 636 can include tickets associated with the services and/or customers respectively corresponding to the services object 628 and the customers object 632.

In some embodiments, the objects 624-636 can also be associated with the visualizations 604-622 from the time selector 602 or navigator. For example, the visualizations 604-622 or icons in the time selector 602 can be used to generate or display a time-based workspace 600 having multiple, related objects (e.g., objects 624-636). Thus, the time selector 602 can allow a user to perform a time-based navigation of the multiple objects 624-636 in the workspace 600.

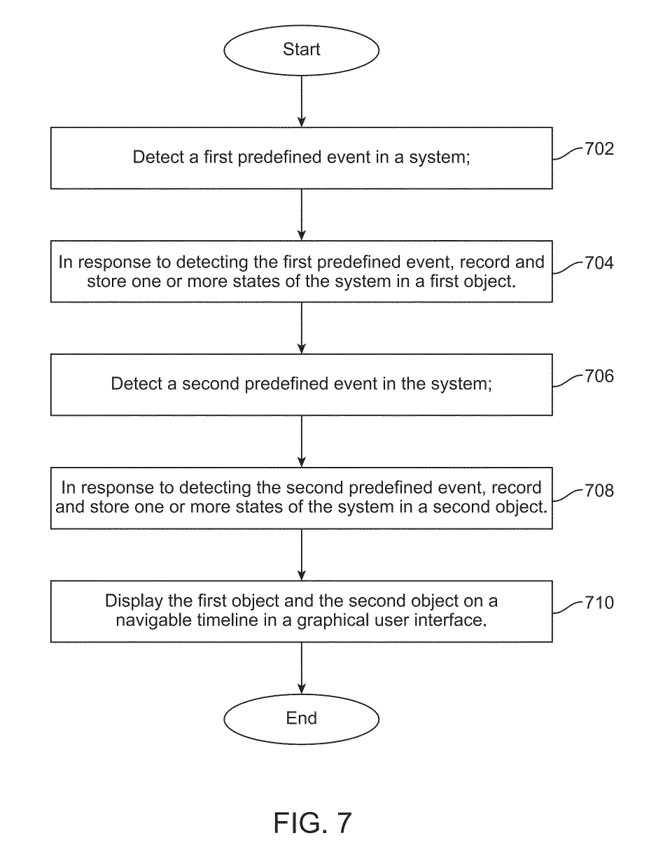

Having disclosed some basic system components and concepts, the disclosure now turns to the example method embodiment shown in FIG. 7. For the sake of clarity, the flowchart is described in terms of a cloud controller 200, as shown in FIG. 2, configured to practice the steps. The steps outlined herein are exemplary and can be implemented in any combination thereof, including combinations that exclude, add, or modify certain steps.

FIG. 7 illustrates an example method for recording system state data and presenting the system state data in a navigable graphical user interface. The example method begins at step 702 and includes detecting a first predefined event in a system. The example method then proceeds to step 704, which includes, in response to detecting the first predefined event, recording and storing one or more states of the system in a first object. The example method then proceeds to step 706, which includes detecting a second predefined event in the system. The example method then proceeds to step 708, which includes, in response to detecting the second predefined event, recording and storing one or more states of the system in a second object. The example method then proceeds to step 710, which includes displaying the first object and the second object on a navigable timeline in a graphical user interface. Although the example method illustrates displaying the first object and the second object on the navigable timeline, this is a non-limiting example and one of ordinary skill in the art will recognize that any number of objects greater than two can also utilize the disclosed technology.

### Example Devices

FIG. 8 illustrates an example network device 810 suitable for high availability and failover. Network device 810 includes a master central processing unit (CPU) 862, interfaces 868, and a bus 815 (e.g., a PCI bus). When acting under the control of appropriate software or firmware, the CPU 862 is responsible for executing packet management, error detection, and/or routing functions, such as miscabling detection functions, for example. The CPU 862 preferably accomplishes all these functions under the control of software including an operating system and any appropriate applications software. CPU 862 may include one or more processors 863 such as a processor from the Motorola family of microprocessors or the MIPS family of microprocessors. In an alternative embodiment, processor 863 is specially designed hardware for controlling the operations of router 810. In a specific embodiment, a memory 861 (such as non-volatile RAM and/or ROM) also forms part of CPU 862. However, there are many different ways in which memory could be coupled to the system.

The interfaces 868 are typically provided as interface cards (sometimes referred to as “line cards”). Generally, they control the sending and receiving of data packets over the network and sometimes support other peripherals used with the router 810. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 862 to efficiently perform routing computations, network diagnostics, security functions, etc.

Although the system shown in FIG. 8 is one specific network device of the present invention, it is by no means the only network device architecture on which the present invention can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 861) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc.

FIG. 9A and FIG. 9B illustrate example system embodiments. The more appropriate embodiment will be apparent to those of ordinary skill in the art when practicing the present technology. Persons of ordinary skill in the art will also readily appreciate that other system embodiments are possible.

FIG. 9A illustrates a conventional system bus computing system architecture 900 wherein the components of the system are in electrical communication with each other using a bus 905. Exemplary system 900 includes a processing unit (CPU or processor) 910 and a system bus 905 that couples various system components including the system memory 915, such as read only memory (ROM) 920 and random access memory (RAM) 925, to the processor 910. The system 900 can include a cache 912 of high-speed memory connected directly with, in close proximity to, or integrated as part of the processor 910. The system 900 can copy data from the memory 915 and/or the storage device 930 to the cache 912 for quick access by the processor 910. In this way, the cache can provide a performance boost that avoids processor 910 delays while waiting for data. These and other modules can control or be configured to control the processor 910 to perform various actions. Other system memory 915 may be available for use as well. The memory 915 can include multiple different types of memory with different performance characteristics. The processor 910 can include any general purpose processor and a hardware module or software module, such as module 1 932 module 2 934, and module 3 936 stored in storage device 930, configured to control the processor 910 as well as a special-purpose processor where software instructions are incorporated into the actual processor design. The processor 910 may essentially be a completely self-contained computing system, containing multiple cores or processors, a bus, memory controller, cache, etc. A multi-core processor may be symmetric or asymmetric.

To enable user interaction with the computing device 900, an input device 945 can represent any number of input mechanisms, such as a microphone for speech, a touch-sensitive screen for gesture or graphical input, keyboard, mouse, motion input, speech and so forth. An output device 935 can also be one or more of a number of output mechanisms known to those of skill in the art. In some instances, multimodal systems can enable a user to provide multiple types of input to communicate with the computing device 900. The communications interface 940 can generally govern and manage the user input and system output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof.

The storage device 930 can include software modules 932 934, 936 for controlling the processor 910. Other hardware or software modules are contemplated. The storage device 930 can be connected to the system bus 905. In one aspect, a hardware module that performs a particular function can include the software component stored in a computer-readable medium in connection with the necessary hardware components, such as the processor 910, bus 905, display 935, and so forth, to carry out the function.

FIG. 9B illustrates an example computer system 950 having a chipset architecture that can be used in executing the described method and generating and displaying a graphical user interface (GUI). Computer system 950 is an example of computer hardware, software, and firmware that can be used to implement the disclosed technology. System 950 can include a processor 955, representative of any number of physically and/or logically distinct resources capable of executing software, firmware, and hardware configured to perform identified computations. Processor 955 can communicate with a chipset 960 that can control input to and output from processor 955. In this example, chipset 960 outputs information to output device 965, such as a display, and can read and write information to storage device 970, which can include magnetic media, and solid state media, for example. Chipset 960 can also read data from and write data to RAM 975. A bridge 980 for interfacing with a variety of user interface components 985 can be provided for interfacing with chipset 960. Such user interface components 985 can include a keyboard, a microphone, touch detection and processing circuitry, a pointing device, such as a mouse, and so on. In general, inputs to system 950 can come from any of a variety of sources, machine generated and/or human generated.

Chipset 960 can also interface with one or more communication interfaces 990 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 955 analyzing data stored in storage 970 or 975. Further, the machine can receive inputs from a user via user interface components 985 and execute appropriate functions, such as browsing functions by interpreting these inputs using processor 955.

It can be appreciated that example systems 900 and 950 can have more than one processor or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further, and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

We claim:

1. A computer-implemented method comprising:
detecting a first predefined event in a system;
in response to detecting the first predefined event, recording and storing one or more states of the system in a first object;
detecting a second predefined event in the system;
in response to detecting the second predefined event, recording and storing one or more states of the system in a second object; and
displaying the first object and the second object on a navigable timeline in a graphical user interface.

2. The computer-implemented method of claim 1, wherein the first predetermined event includes a lifecycle and wherein the recording and storing one or more states of the system in the first object further includes recording and storing a first state of the system at a first stage of the lifecycle of the first predetermined event and recording and storing a second state of the system at a second stage of the lifecycle of the first predetermined event.

3. The computer-implemented method of claim 2, wherein displaying the first object on the navigable timeline in the graphical user interface further includes displaying a sub-object representing the first state of the system at the first stage of the lifecycle and displaying a sub-object representing the second state of the system at the second stage.

4. The computer-implemented method of claim 3, wherein the displaying the sub-object representing the first state of the system at the first stage of the lifecycle and displaying the sub-object representing the second state of the system at the second stage only occur in response to receiving a user input.

5. The computer-implemented method of claim 1, wherein the displaying the first object and the second object on the navigable timeline in the graphical user interface further includes displaying the first object and second object in chronological order.

6. The computer-implemented method of claim 1, wherein the first or second predefined event in the system is a virtual private network, firewall, remote access, or web security network error.

7. A system comprising:
a processor; and
a computer-readable storage medium having stored therein instructions which, when executed by the processor, cause the processor to perform operations comprising:
detecting a first predefined event in a system;
in response to detecting the first predefined event, recording and storing one or more states of the system in a first object;
detecting a second predefined event in the system;
in response to detecting the second predefined event, recording and storing one or more states of the system in a second object; and
displaying the first object and the second object on a navigable timeline in a graphical user interface.

8. The system of claim 7, wherein each of the segments further comprises at least one sub-segment corresponding to a respective sub-category of network elements, wherein the respective sub-category of network elements comprises a respective number of network elements having a specific current condition ascertained from the network traffic.

9. The system of claim 8, wherein displaying the first object on the navigable timeline in the graphical user interface further includes displaying a sub-object representing the first state of the system at the first stage of the lifecycle and displaying a sub-object representing the second state of the system at the second stage.

10. The system of claim 7, wherein the displaying the first object and the second object on the navigable timeline in the graphical user interface further includes displaying the first object and second object in chronological order.

11. The system of claim 7, wherein the first or second predefined event in the system is a virtual private network, firewall, remote access, or web security network error.

12. A non-transitory computer-readable storage medium having stored therein instructions which, when executed by a processor, cause the processor to perform operations comprising:
detecting a first predefined event in a system;
in response to detecting the first predefined event, recording and storing one or more states of the system in a first object;
detecting a second predefined event in the system;
in response to detecting the second predefined event, recording and storing one or more states of the system in a second object; and
displaying the first object and the second object on a navigable timeline in a graphical user interface.
The computer-readable storage medium of claim 1, wherein the first predetermined event includes a lifecycle and wherein the recording and storing one or more states of the system in the first object further includes recording and storing a first state of the system at a first stage of the lifecycle of the first predetermined event and recording and storing a second state of the system at a second stage of the lifecycle of the first predetermined event.

13. The non-transitory computer-readable storage medium of claim 12, wherein the first predetermined event includes a lifecycle and wherein the recording and storing one or more states of the system in the first object further includes recording and storing a first state of the system at a first stage of the lifecycle of the first predetermined event and recording and storing a second state of the system at a second stage of the lifecycle of the first predetermined event.

14. The non-transitory computer-readable storage medium of claim 13, wherein displaying the first object on the navigable timeline in the graphical user interface further includes displaying a sub-object representing the first state of the system at the first stage of the lifecycle and displaying a sub-object representing the second state of the system at the second stage.

15. The non-transitory computer-readable storage medium of claim 14, wherein the displaying the sub-object representing the first state of the system at the first stage of the lifecycle and displaying the sub-object representing the second state of the system at the second stage only occur in response to receiving a user input.

16. The non-transitory computer-readable storage medium of claim 12, wherein the displaying the first object and the second object on the navigable timeline in the graphical user interface further includes displaying the first object and second object in chronological order.

17. The non-transitory computer-readable storage medium of claim 12, wherein the first or second predefined event in the system is a virtual private network, firewall, remote access, or web security network error.
